(19) United States
(12) Patent Application Publication
(10) Pub. No.: US 2008/0207367 A1
(43) Pub. Date: Aug. 28, 2008

(54) TENSIONING DEVICE FOR A BELT DRIVE

(75) Inventors: Michael Bogner, Eckental (DE); Matthias Schmidl, Eckental (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/773,998

(22) Filed: Jul. 6, 2007

(30) Foreign Application Priority Data
Jul. 7, 2006 (DE) 102006031518.9

(51) Int. Cl. F16H 7/12

(52) U.S. Cl. 474/133

(57) ABSTRACT

A tensioning device for a belt drive is provided, with a lever arm, which is rotatably supported on a base plate with a damping mechanism and on which a pulley and a spring element can be or are mounted. An arrangement is provided to prevent automatic loosening of the screw connection between the lever arm (3, 15) and the bearing.

### FIELD OF THE INVENTION

The invention relates to a tensioning device for a belt drive comprising a lever arm, which is rotatably supported on a base plate using a damping mechanism support arrangement on which a pulley and a spring element can be or is mounted.

### BACKGROUND

Tensioning devices of this type are already known, for example, from DE 196 31 507 A1 or DE 102 51 859 A1. In these tensioning devices, in the region of the support, a damping mechanism is provided comprising friction elements. For reasons of cost, it is desirable to replace the hydraulic tensioning device that is typically used by a mechanical tensioning device, in which the damping function is generated just by the support with the damping mechanism, without increasing the necessary installation space. Here high demands are placed on the damping mechanism, because the threaded connection of the support must safely transmit and withstand not only the resulting transverse forces, but also the effective damping moment. During operation the threaded connection is exposed to an alternating load, because the direction of the effective torque reverses continuously.

### SUMMARY

The invention is based on the objective of creating a tensioning device for a belt drive, in which the threaded connection withstands the resulting alternating loads.

To meet this objective, in a tensioning device for a belt drive of the type noted above, means are provided, which prevent automatic loosening of the threaded connection between the lever arm and the support.

According to a first embodiment of the invention, it is provided that the means comprise a bolt connected rigidly to the base plate and a flange. In this construction, an especially good hold is achieved, particularly when the bolt is pressed into the base plate.

According to an alternative construction of the tensioning device according to the invention, the bolt and the base plate can be constructed as an integral component, in particular, they can be produced from an aluminum alloy.

Within the scope of the invention, it can also be provided that the spring element is supported pre-tensioned on the lever arm. In this case, the unit can be delivered pre-tensioned, so that during installation, the processing step of tensioning the belt drive is eliminated.

According to one refinement of the invention, the base plate and the lever arm in the pre-tensioned state can be secured by a locking pin.

After mounting the base plate on the housing of an internal combustion engine or on an add-on part, the belt is placed on the pulley and the other components of the belt drive, the locking pin is removed, and the belt drive is automatically tensioned by the energy stored in the spring element.

To prevent undesired loosening of the threaded connection, it can be provided in the tensioning device according to the invention that the base plate has a retaining element preventing its rotation and forming a positive lock. In particular, the retaining element can include a pin projecting from the base plate, preferably projecting in the radial or axial direction away from the base plate. Alternatively, the retaining element can include a recess, which interacts with a corresponding, diametrically opposite projection or pin. The retaining element has the effect that the threaded connection does not loosen despite the resulting torque of changing sign.

As another or additional means for preventing undesired loosening of the threaded connection, the bolt can be constructed as an expanding screw, similarly the thread of the bolt can be provided with microencapsulated bonding agent, which bonds the threading of the bolt to the corresponding internal threading when tightening the screw.

Fundamentally it is also possible to use the invention in tensioning devices, in which the support and the damping are separated from each other spatially.

### BRIEF DESCRIPTION OF THE DRAWINGS

Additional advantages and details of the invention are explained using embodiments with reference to the figures. The figures are schematic representations and show:

FIG. 1 and FIG. 2a first embodiment of a tensioning device according to the invention;

FIG. 3 and FIG. 4a second embodiment of a tensioning device according to the invention;

FIG. 5 and FIG. 6a third embodiment of a tensioning device according to the invention; and

FIG. 7 a fourth embodiment of a tensioning device according to the invention.

### DETAILED DESCRIPTION OF THE PREFERRED EMBODIMENTS

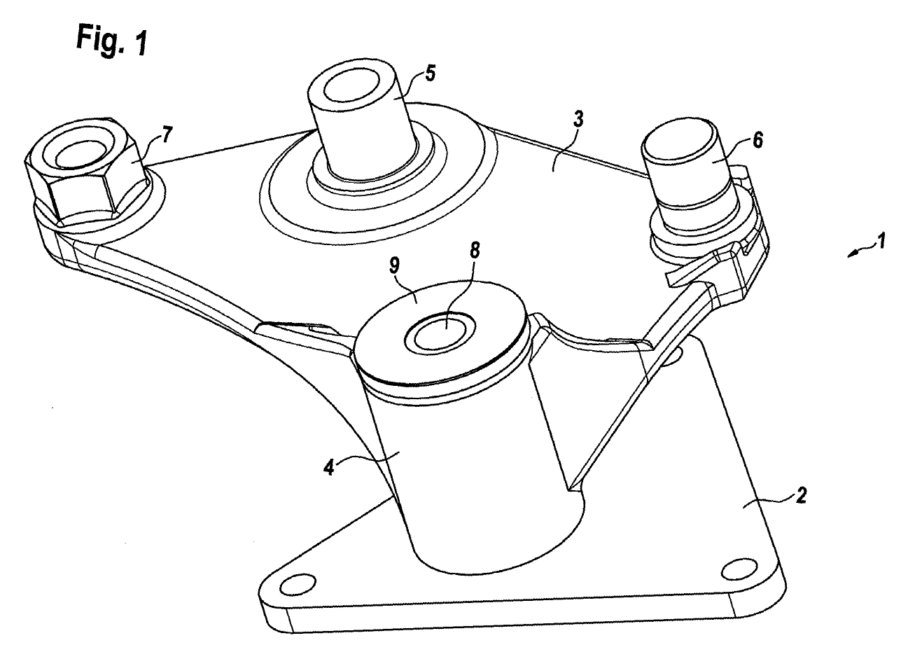

FIG. 1 shows, in a perspective representation, a tensioning device 1 for a belt drive of an internal combustion engine. The tensioning device 1 comprises a base plate 2, which can be mounted on the block or a housing of an internal combustion engine or on an add-on part. A lever arm 3 is supported so that it can rotate by means of a bearing lug 4 on the base plate 2. The lever arm 3 further comprises a bolt 5 for mounting a pulley and another bolt 6 for mounting a spring element. A mounting hexagon 7, on which a tool can be set for tensioning the belt drive, is arranged on the base plate 2 opposite the bolt 6.

In the interior of the bearing lug 4 there is a damping mechanism in order to damp vibrations in the belt drive, especially vibrations of the belt and thus the lever arm 3. In other constructions, the damping mechanism can be arranged spatially separated from the bearing lug. The vibration energy is here dissipated by friction elements in the damping mechanism, which act between the bearing lug 4 and a bolt 8 connected rigidly to the base plate 2. The bolt 8 is pressed into the base plate 2 and has a circular flange 9 on its free end.

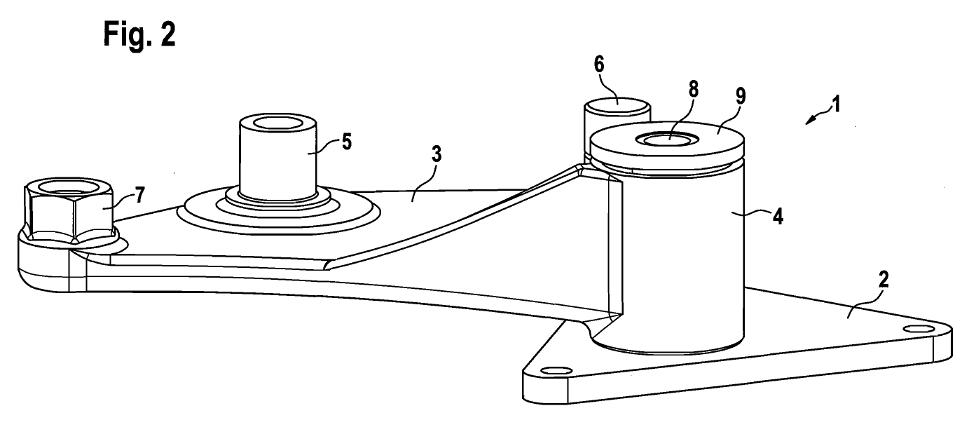

In the tensioning device 1 shown in FIG. 1, a mechanical tensioning element, for example, a tension spring or compression spring, can be used, a hydraulic tensioning element is not necessary, because the damping element arranged in the interior of the bearing lug 4 sufficiently damps the resulting movements and vibrations. Here the mounting of the bolt 8 on the base plate 2 and the flange 9 is of great importance. In the tensioning device 1 shown in FIGS. 1 and 2, it is guaranteed that this connection can withstand the resulting torques with alternating sign. In other constructions, the bolt can also be produced integrally with the base plate.

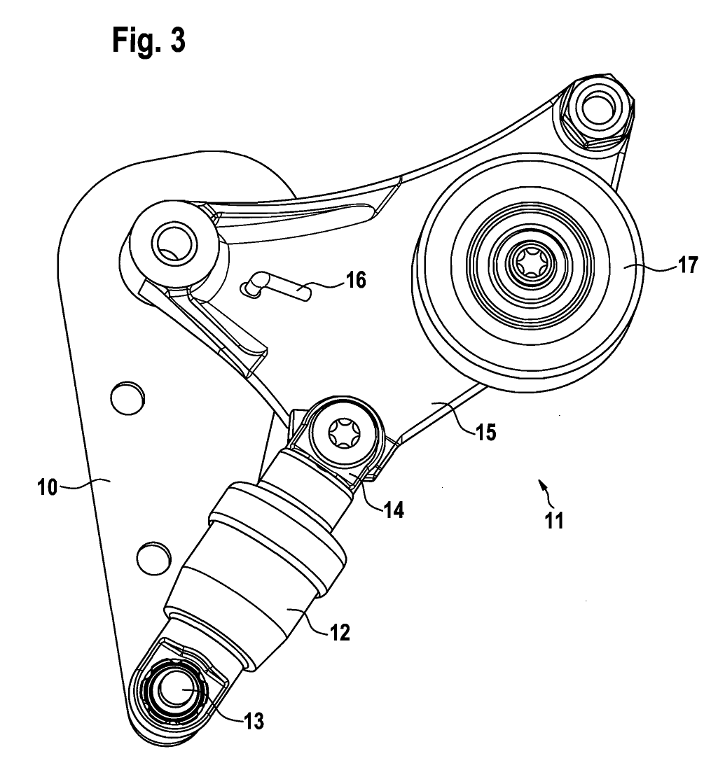

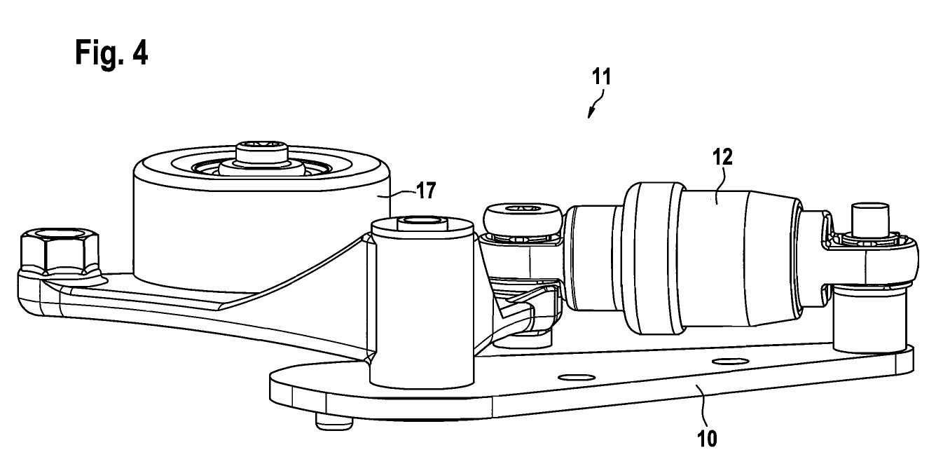

FIGS. 3 and 4 show a second embodiment of a tensioning device. The base plate 10 of the tensioning device 11 is enlarged relative to the base plate of the first embodiment and is simultaneously used for supporting a spring element 12. One end of the spring element 12 is supported by a bearing lug 13 on the base plate 10 and the other end 14 of the spring element 12 is connected in an articulated way to the lever arm 15. A locking pin 16 is inserted through an opening in the lever arm 15 into a recess of the base plate 10 and holds the tensioning device 11 in the pre-tensioned position. After mounting the base plate 10 of the tensioning device 11 on the housing of an internal combustion engine, the locking pin 16 is removed and the belt placed on the pulley 17 is automatically tensioned.

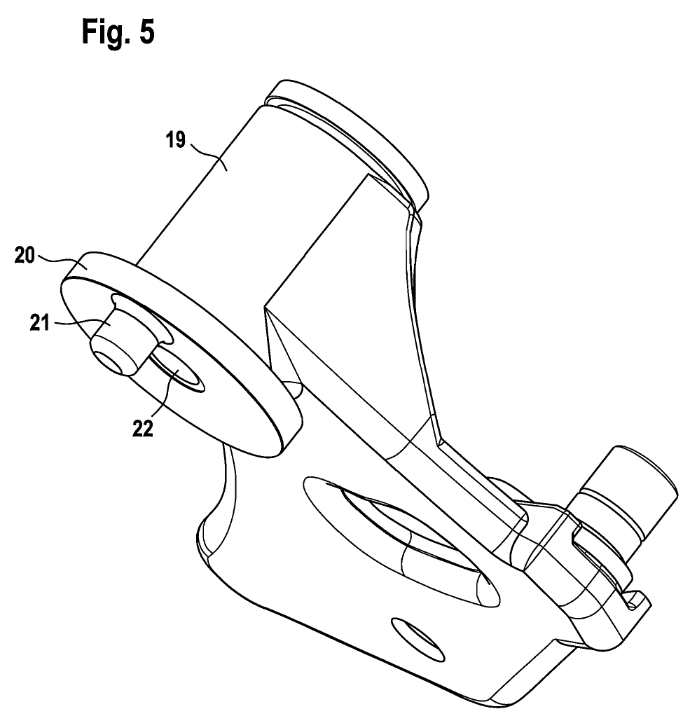

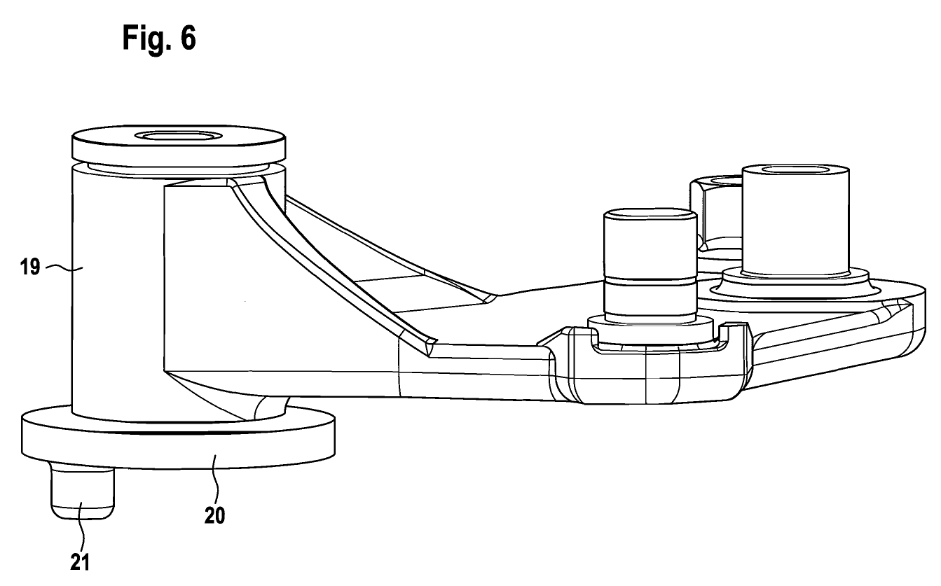

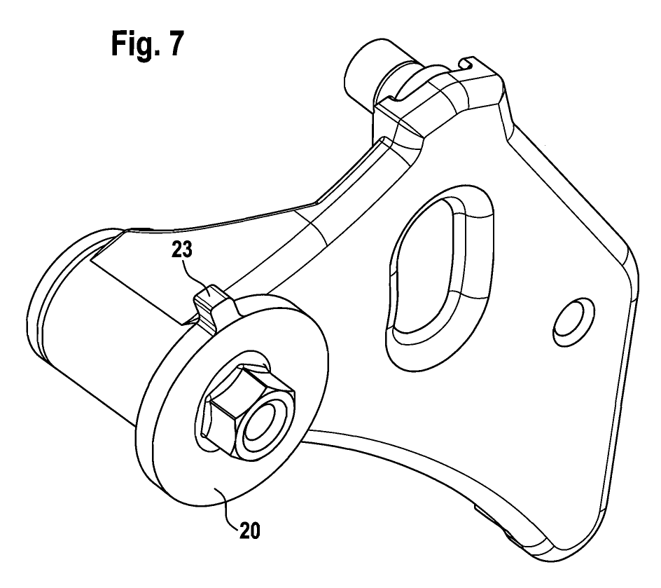

FIGS. 5 and 6 show a third embodiment of a tensioning device. A retaining element, which forms a positive lock and which is constructed as a cylindrical pin 21, is arranged on the side of the base plate 20 opposite the bearing lug 19 in the tensioning device 18. The pin 21 is inserted into a corresponding recess, which can be located on the housing of the internal combustion engine or a different add-on part and effectively prevents loosening of the threaded connection, by which the bearing lug 19 and the base plate 20 are connected to each other. The screw 22 is here constructed as an expanding screw, whose threading has a microencapsulated bonding agent, so that the threading of the screw 22 is bonded to the corresponding internal threading of the base plate 20 during assembly. In other configurations, the pin can project radially from the base plate 20, conversely the base plate 20 can naturally also have a corresponding recess, in which an equally constructed retaining element, for example, a pin, is engaged in order to create a positive lock. FIG. 7 shows such an embodiment with a pin 23 projecting radially from the base plate 20.

### REFERENCE NUMBERS

1 Tensioning device
2 Base plate
3 Lever arm
4 Bearing lug
5 Bolt
6 Bolt
7 Mounting hexagon
8 Bolt
9 Flange
10 Base plate
11 Tensioning device
12 Spring element
13 Bearing lug
14 End of the spring element
15 Lever arm
16 Locking pin
17 Pulley
18 Tensioning device
19 Bearing lug
20 Base plate
21 Pin
22 Screw
23 Pin

1. Tensioning device for a belt drive, comprising a lever arm, which is supported so that it can rotate on a base plate by a bearing with a damping mechanism and on which a pulley and a spring element can be or are mounted, and means are provided, for preventing automatic loosening of the screwed connection between the lever arm and the bearing.

2. Tensioning device according to claim 1, wherein the means comprise a bolt connected rigidly to the base plate and a flange.

3. Tensioning device according to claim 2, wherein the bolt and the base plate are constructed as an integral component.

4. Tensioning device according to claim 2, wherein the spring element is supported pre-tensioned on the lever arm.

5. Tensioning device according to claim 4, wherein the base plate and the lever arm are secured in a pre-tensioned state by a locking pin.

6. Tensioning device according to claim 2, wherein the base plate has a retaining element preventing rotation thereof and forming a positive lock.

7. Tensioning device according to claim 6, wherein the retaining element comprises a pin projecting from the base plate.

8. Tensioning device according to claim 7, wherein the pin projects axially or radially from the base plate.

9. Tensioning device according to claim 6, wherein the retaining element has a recess, which interacts with a corresponding complementary projection.

10. Tensioning device according to claim 2, wherein the bolt is constructed as an expanding screw.

11. Tensioning device according to one of claim 2, wherein threads of the bolt are provided with a microencapsulated bonding agent.
